(19) United States
(12) Patent Application Publication
(10) Pub. No.: US 2016/0336883 A1
(43) Pub. Date: Nov. 17, 2016

(54) SEMICONDUCTOR DEVICE AND MOTOR DRIVING METHOD

(71) Applicant: Kabushiki Kaisha Toshiba, Tokyo (JP)

(72) Inventor: Kenichi Nakano, Yokohama Kanagawa (JP)

(21) Appl. No.: 14/847,590

(22) Filed: Sep. 8, 2015

(30) Foreign Application Priority Data
May 11, 2015 (JP) 2015-096745

(51) Int. Cl. H02P 6/00; H02P 6/14

(52) U.S. Cl. CPC H02P 6/008; H02P 6/14

(57) ABSTRACT

According to an embodiment, a semiconductor device includes a first switching circuit, at least one second switching circuit, and a switch control circuit. The first switching circuit drives a motor. The second switching circuit is connected in parallel to the first switching circuit, and supplies a current to the motor. The switch control circuit controls whether or not to drive the second switching circuit in accordance with a current flowing to the motor.

### CROSS-REFERENCE TO RELATED APPLICATIONS

This application is based upon and claims the benefit of priority from Japanese Patent Application No. 2015-096745, filed on May 11, 2015; the entire contents of which are incorporated herein by reference.

### FIELD

The present embodiment relates to a semiconductor device and a motor driving method.

### BACKGROUND

An art of driving a motor by switching control a load current which is flowed in the motor by using a switching device, is known. For example, when a MOSFET is used as the switching device, it is effective to reduce a switching loss and a continuity loss of the MOSFET so as to improve driving efficiency of the motor. Specifically, it is effective to reduce the switching loss of the MOSFET in a low load current region, and it is effective to reduce the continuity loss of the MOSFET in a high load current region.

As a means of reducing the switching loss of the MOSFET, for example, reducing an input capacitance can be cited. On the other hand, as a means of reducing the continuity loss of the MOSFET, for example, reducing an on-resistance can be cited. However, there is a trade-off relationship between the input capacitance and the on-resistance. Therefore, it is difficult to reduce both the switching loss and the continuity loss. Namely, it is difficult to reduce the losses in both the low current region and the high current region.

A problem to be solved by the present invention is to provide a semiconductor device, and a motor driving method capable of reducing the losses regardless of the current regions.

### BRIEF DESCRIPTION OF THE DRAWINGS

FIG. 1 is a block diagram illustrating a schematic circuitry of a semiconductor device according to a first embodiment;

FIG. 2 is a graphic chart to explain an effect of the semiconductor device according to the first embodiment;

FIG. 3 is a block diagram illustrating a schematic circuitry of a semiconductor device according to a second embodiment;

FIG. 4 is a block diagram illustrating a schematic circuitry of a semiconductor device according to a third embodiment;

FIG. 5 is a block diagram illustrating a schematic circuitry of a semiconductor device according to a fourth embodiment;

FIG. 6 is a graphic chart comparing characteristics between an IGBT and a MOSFET.

### DETAILED DESCRIPTION

Embodiments will now be explained with reference to the accompanying drawings. The present invention is not limited to the embodiments.

### First Embodiment

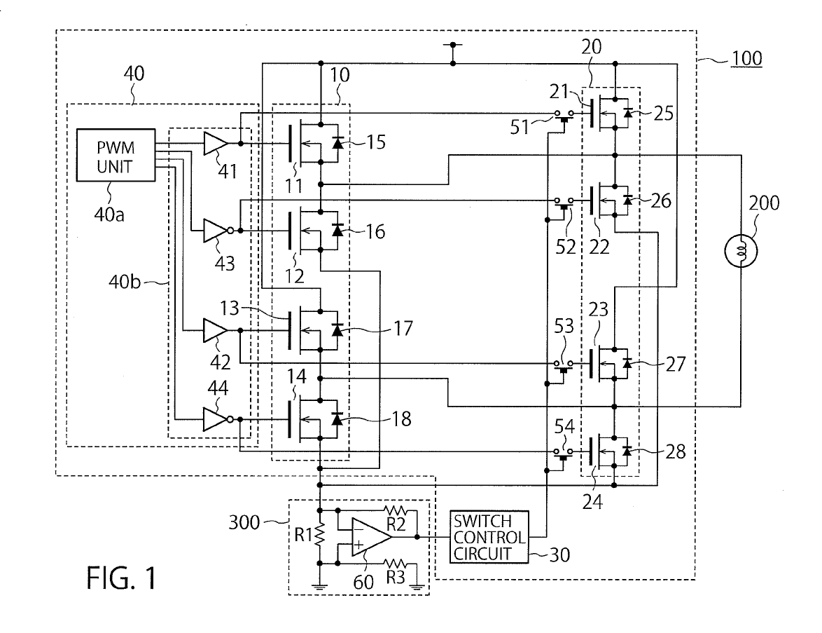

FIG. 1 is a block diagram illustrating a schematic circuitry of a semiconductor device according to a first embodiment. In FIG. 1, not only a semiconductor device 100 according to the embodiment but also a motor 200 and a current detection circuit 300 are illustrated. The motor 200 is a single phase brushless motor which is driven by the semiconductor device 100 according to the embodiment, but it may be a single phase motor of other kinds. The current detection circuit 300 is a circuit to detect a load current flowing in the motor 200. In the embodiment, the current detection circuit 300 is externally attached to the semiconductor device 100, but it may be housed in the semiconductor device 100. Note that a configuration of the current detection circuit 300 may be described later.

As illustrated in FIG. 1, the semiconductor device 100 of the embodiment includes a main switching circuit 10, an auxiliary switching circuit 20, a switch control circuit 30, and a drive control circuit 40. Schematically, the main switching circuit 10 switch-controls the load current to thereby drive the motor 200. The auxiliary switching circuit 20 is connected in parallel to the main switching circuit 10, and a part of the load current is supplied to the motor 200 when the auxiliary switching circuit 20 is driven. The switch control circuit 30 controls whether or not the auxiliary switching circuit 20 is driven in accordance with the load current. The drive control circuit 40 is a circuit to drive the main switching circuit 10 and the auxiliary switching circuit 20. Hereinafter, configurations of respective circuits are described in detail.

### Main Switching Circuit 10

As illustrated in FIG. 1, the main switching circuit 10 includes main switching devices 11 to 14 and diodes 15 to 18 respectively connected in parallel to the main switching devices 11 to 14. The main switching circuit 10 constitutes a first switching circuit, and the main switching devices 11 to 14 constitute first switching devices. In the embodiment, the main switching devices 11 to 14 are n-channel type MOSFETs, and the diodes 15 to 18 are so-called body diodes housed in the MOSFETs.

The main switching devices 11 to 14 are connected so as to constitute a circuit for driving a motor, so-called an H-bridge circuit. Specifically, the main switching device 11 and the main switching device 12 are connected in series, and a source of the main switching device 11 and a drain of the main switching device 12 are connected to one connection terminal of the motor 200. Similarly, the main switching device 13 and the main switching device 14 are connected in series, and a source of the main switching device 13 and a drain of the main switching device 14 are connected to the other connection terminal of the motor 200. Gates of the main switching devices 11 to 14 are connected to the drive control circuit 40.

### Auxiliary Switching Circuit 20

As illustrated in FIG. 1, the auxiliary switching circuit 20 includes auxiliary switching devices 21 to 24 and diodes 25 to 28 respectively connected in parallel to the auxiliary switching devices 21 to 24. The auxiliary switching circuit 20 constitutes a second switching circuit, and the auxiliary switching devices 21 to 24 constitute second switching devices. In the embodiment, the auxiliary switching devices 21 to 24 are n-channel type MOSFETs as same as the main switching devices 11 to 14, but device characteristics of them such as the on-resistance and the switching loss may be the same as the main switching devices 11 to 14 or different. Namely, sizes of the auxiliary switching devices 21 to 24 may be the same as sizes of the main switching devices 11 to 14 or different. Besides, in the embodiment, the diodes 25 to 28 are body diodes housed in the MOSFETs as same as the diodes 15 to 18.

The auxiliary switching device 21 and the auxiliary switching device 22 are connected in series, and a source of the auxiliary switching device 21 and a drain of the auxiliary switching device 22 are connected to one connection terminal of the motor 200. Similarly, the auxiliary switching device 23 and the auxiliary switching device 24 are connected in series, and a source of the auxiliary switching device 23 and a drain of the auxiliary switching device 24 are connected to the other connection terminal of the motor 200. Gates of the auxiliary switching devices 21 to 24 are connected to the drive control circuit 40 via switches 51 to 54.

Further, the auxiliary switching device 21 is connected in parallel to the main switching device 11. Similarly, the auxiliary switching devices 22 to 24 are respectively connected in parallel to the main switching devices 12 to 14.

### Switch Control Circuit 30 and Current Detection Circuit 300

At first, the current detection circuit 300 is described. As illustrated in FIG. 1, the current detection circuit 300 includes resistors R1 to R3 and an operational amplifier 60. The resistor R1 is a resistor for current detection, and is connected in series to sources of the main low side switching devices 12, 14, and sources of the auxiliary low side switching devices 22, 24. Besides, a − input terminal of the operational amplifier 60 is connected to one end of the resistor R1, and a + input terminal of the operational amplifier 60 is connected to the other end of the resistor R1. The − input terminal of the operational amplifier 60 is connected to an output terminal via the resistor R2. The + input terminal of the operational amplifier 60 is grounded via the resistor R3. The operational amplifier 60 outputs a signal in which a voltage difference between the − input terminal and the + input terminal is amplified from the output terminal. This voltage difference corresponds to the load current of the motor 200. Namely, the operational amplifier 60 outputs a current detection signal corresponding to the load current of the motor 200 to the switch control circuit 30.

Next, the switch control circuit 30 is described. The switch control circuit 30 controls the switches 51 to 54 based on the current detection signal. Specifically, when the load current corresponding to the current detection signal is equal to or less than a threshold value which is set in advance, the switch control circuit 30 keeps all of the switches 51 to 54 in off states. In this case, the auxiliary switching circuit 20 is not driven, and therefore, the load current is supplied to the motor 200 only from the main switching circuit 10.

On the other hand, when the load current corresponding to the current detection signal is more than the threshold value, the switch control circuit 30 switches all of the switches 51 to 54 from the off states to on states at a similar timing. In this case, the auxiliary switching circuit 20 is driven, and a part of the load current is supplied to the motor 200 from the auxiliary switching circuit 20. In other words, the main switching circuit 10 and the auxiliary switching circuit 20 are synchronously driven, and the load current is supplied to the motor 200 from each of the main switching circuit 10 and the auxiliary switching circuit 20.

### Drive Control Circuit 40

As illustrated in FIG. 1, the drive control circuit 40 includes a PWM unit 40a and a pre-driver circuit 40b. The PWM unit 40a generates a PWM signal, and supplies the generated PWM signal to the pre-driver circuit 40b. Note that this PWM unit 40a may constitute an MCU (Micro Control Unit) together with the operational amplifier 60 and the switch control circuit 30 to be provided at one chip.

The pre-driver circuit 40b includes buffer circuits 41, 42, and inversion circuits 43, 44. The buffer circuit 41 amplifies the PWM signal which is supplied from the PWM unit 40a, and outputs the amplified PWM signal to the gate of the main switching device 11. At this time, when the switch 51 which is connected to the buffer circuit 41 is in the on state, the PWM signal amplified at the buffer circuit 41 is also output to the gate of the auxiliary switching device 21.

The buffer circuit 42 amplifies the PWM signal which is supplied from the PWM unit 40a as same as the buffer circuit 41, and outputs the amplified PWM signal to the gate of the main switching device 13. At this time, when the switch 53 which is connected to the buffer circuit 42 is in the on state, the PWM signal amplified at the buffer circuit 42 is also output to the gate of the auxiliary switching device 23.

The inversion circuit 43 inverse-amplifies the PWM signal which is supplied from the PWM unit 40a, and outputs the inverse-amplified PWM signal to the gate of the main switching device 12. At this time, when the switch 52 which is connected to the inversion circuit 43 is in the on state, the PWM signal inverse-amplified at the inversion circuit 43 is also output to the gate of the auxiliary switching device 22.

The inversion circuit 44 inverse-amplifies the PWM signal which is supplied from the PWM unit 40a as same as the inversion circuit 43, and outputs the inverse-amplified PWM signal to the gate of the main switching device 14. At this time, when the switch 54 which is connected to the inversion circuit 44 is in the on state, the PWM signal inverse-amplified at the inversion circuit 44 is also output to the gate of the auxiliary switching device 24.

At the pre-driver circuit 40b, a polarity of the PWM signal output from the buffer circuit 41 and a polarity of the PWM signal output from the inversion circuit 43 are different from one another. Similarly, a polarity of the PWM signal output from the buffer circuit 42 and a polarity of the PWM signal output from the inversion circuit 44 are also different from one another. Accordingly, the main switching device 11 and the main switching device 12 are not simultaneously turned on, and the main switching device 13 and the main switching device 14 are not simultaneously turned on. A short circuit state in which a shoot-through current flows in the main switching circuit 10 can be thereby avoided.

Note that at the pre-driver circuit 40b, a dead time may be set. Specifically, after the polarity of the PWM signal output from either one of the buffer circuit 41 or the inversion circuit 43 is switched from high-level to low-level, the polarity of the PWM signal output from the other circuit may be kept in a state of low-level until a certain period of time elapses. Similarly, after the polarity of the PWM signal output from either one of the buffer circuit 42 or the inversion circuit 44 is switched from high-level to low-level, the polarity of the PWM signal output from the other circuit may be kept in a state of low-level until a certain period of time elapses. It is thereby possible to perform a switching control in consideration of a switching time of the switching devices with each other which are not to be simultaneously turned on such as, for example, the main switching devices 11, 12. As a result, it becomes possible to more certainly avoid the short-circuit state of the main switching circuit 10.

Hereinafter, drive operations of the motor 200 using the semiconductor device 100 according to the embodiment are described.

At first, the PWM unit 40a generates the PWM signal, and outputs the generated PWM signal to the pre-driver circuit 40b. At the pre-driver circuit 40b, the buffer circuits 41, 42 each amplify the PWM signal output from the PWM unit 40a, and respectively output the amplified PWM signals to the main switching devices 11, 13. Besides, the inversion circuits 43, 44 each inverse-amplify the PWM signal output from the PWM unit 40a, and respectively output the inverse-amplified PWM signals to the main switching devices 12, 14. The main switching devices 11 to 14 each perform a switching operation based on the PWM signal.

The load current is supplied to the motor 200 by the switching operations of the main switching devices 11 to 14. The current detection circuit 300 detects the load current, and outputs the current detection signal which corresponds to the detected load current to the switch control circuit 30.

When the load current detected at the current detection circuit 300 is equal to or less than the threshold value, the switch control circuit 30 keeps all of the switches 51 to 54 in the off states. In this case, the auxiliary switching circuit 20 is not driven, and therefore, only the main switching circuit 10 is driven.

After that, when the load current detected at the current detection circuit 300 is more than the threshold value, the switch control circuit 30 switches all of the switches 51 to 54 from the off states to the on states at the same timing. In this case, the PWM signals which are the same as the main switching devices 11 to 14 are input to the auxiliary switching devices 21 to 24 from the pre-driver circuit 40b. Therefore, the auxiliary switching devices 21 to 24 perform the switching operations at the same timing as the main switching devices 11 to 14. In other words, the auxiliary switching circuit 20 is synchronously driven with the main switching circuit 10.

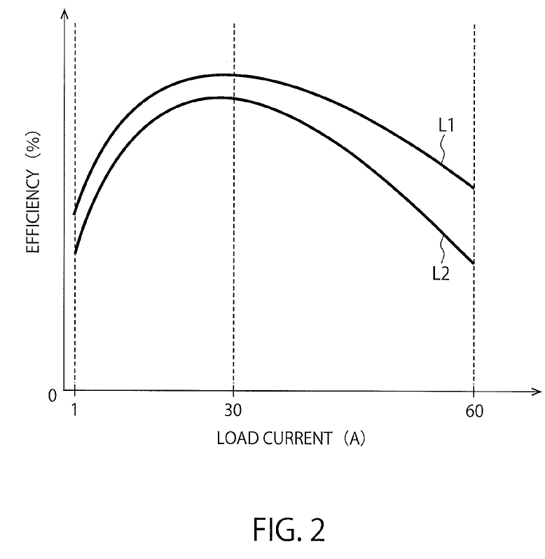

Hereinafter, effects of the semiconductor device 100 according to the embodiment are described with reference to FIG. 2. FIG. 2 is a graphic chart to explain the effects of the semiconductor device 100 according to the embodiment.

In FIG. 2, a horizontal axis is a load current flowed in a motor, and a vertical axis is drive efficiency of the motor. The drive efficiency is a value in which an output voltage in the motor is divided by an input voltage. Besides, a line L1 is a line representing characteristics of the semiconductor device 100 of the embodiment, and a line L2 is a line representing characteristics of a semiconductor device according to a comparative example.

In the semiconductor device of the comparative example, the auxiliary switching circuit 20 and the switch control circuit 30 are not provided. Namely, in the semiconductor device of the comparative example, only a main switching device of a main switching circuit performs switching operations regardless of a level of a load current. In the comparative example, for example, when a range of the load current is 1 A to 60 A as illustrated in FIG. 2, the main switching device of the main switching circuit is a MOSFET rated at 60 A.

On the other hand, in the semiconductor device 100 according to the embodiment, for example, when the load current is equal to or less than 30 A, only the main switching circuit 10 is driven, and both of the main switching circuit 10 and the auxiliary switching circuit 20 are driven when the load current is more than 30 A. Namely, it is possible to use the MOSFETs whose current ratings are smaller than the MOSFET of the comparative example for the main switching devices 11 to 14 of the main switching circuit 10. Therefore, it becomes possible to set input capacitances of the main switching devices 11 to 14 to be smaller than an input capacitance of the MOSFET of the comparative example. In other words, it becomes possible to reduce switching losses of the main switching devices 11 to 14 compared to a switching loss of the MOSFET of the comparative example. It is thereby possible to improve the drive efficiency of the motor in a low-current region.

Besides, when the load current is more than 30 A, the main switching devices 11 to 14 of the main switching circuit 10 and the auxiliary switching devices 21 to 24 of the auxiliary switching circuit 20 perform the switching operations. At this time, the main switching devices 11 to 14 of the main switching circuit 10 and the auxiliary switching devices 21 to 24 of the auxiliary switching circuit 20 are connected in parallel, and therefore, a combined on-resistance in which an on-resistance of the main switching devices 11 to 14 and an on-resistance of the auxiliary switching devices 21 to 24 of the auxiliary switching circuit are combined becomes an on-resistance of the semiconductor device 100. For example, when characteristics of the on-resistances are the same between the main switching devices 11 to 14 and the auxiliary switching devices 21 to 24, the combined on-resistance becomes a half. A continuity loss is thereby reduced, and therefore, it becomes possible to improve the drive efficiency of the motor in a large current region.

In the semiconductor device 100 according to the embodiment described hereinabove, only the main switching circuit 10 is driven in the low-current region. The current ratings of the main switching devices 11 to 14 are small compared to the comparative example, and therefore, it is possible to reduce the switching loss compared to the comparative example. Besides, the switch control circuit 30 drives both of the main switching circuit 10 and the auxiliary switching circuit 20 in the high-current region, and thereby, the continuity loss is reduced. Therefore, according to the semiconductor device 100 of the embodiment, it is possible to reduce the losses regardless of the current regions.

### Second Embodiment

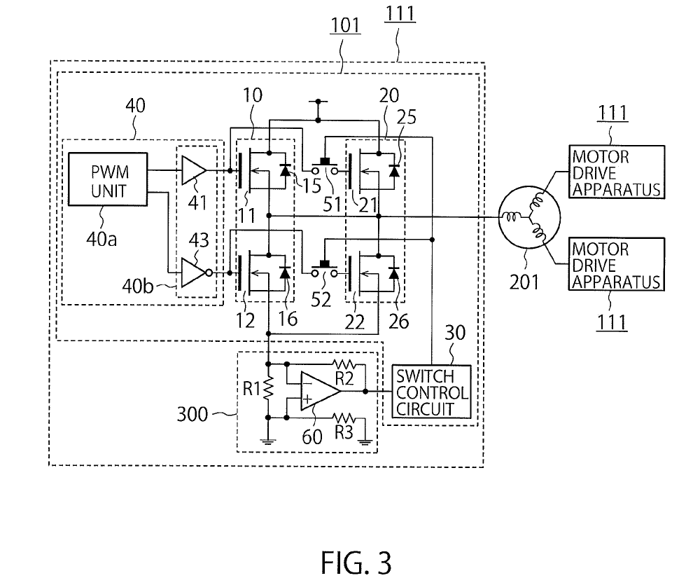

A semiconductor device according to a second embodiment is described. FIG. 3 is a view illustrating a schematic configuration of a semiconductor device 101 according to the second embodiment. The same reference numerals are supplied for components similar to the semiconductor device 100 according to the first embodiment, and detailed descriptions thereof are not given.

As illustrated in FIG. 3, the semiconductor device 101 according to the embodiment is different from the semiconductor device 100 according to the first embodiment in a point that it is applied for a drive of a three-phase motor 201. Note that in the embodiment, the motor 201 is a three-phase brushless motor, but it may be a three-phase motor of other kinds.

In the embodiment, motor drive apparatus 111 are provided to correspond to respective phases of the motor 201. The motor drive apparatus 111 includes the semiconductor device 101 and the current detection circuit 300. A configuration of the current detection circuit 300 is similar to the first embodiment, and therefore, the description is not given, and a configuration of the semiconductor device 101 is described below.

As illustrated in FIG. 3, the semiconductor device 101 of the embodiment includes the main switching circuit 10, the auxiliary switching circuit 20, the switch control circuit 30, and the drive control circuit 40 as same as the semiconductor device 100 of the first embodiment. Configurations of these circuits are almost similar to the first embodiment, but the main switching circuit 10 is configured to the switching devices 11, 12 and the diodes 15, 16, the auxiliary switching circuit 20 is configured to the switching devices 21, 22 and the diodes 25, 26, and the pre-driver circuit 40b is configured to the buffer circuit 41 and the inversion circuit 43. Further, the semiconductor device 101 of the embodiment includes the switches 51, 52.

Hereinafter, drive operations of the motor 201 using the semiconductor device 101 of the embodiment are described.

Also in the embodiment, when the load current detected at the current detection circuit 300 is equal to or less than the threshold value, the switch control circuit 30 keeps the switches 51, 52 in the off states as same as the first embodiment. Accordingly, the PWM signal generated at the PWM unit 40a is input only to the main switching circuit 10 via the pre-driver circuit 40b. Only the main switching devices 11, 12 whose input capacitances are small perform the switching operations, and therefore, the switching loss is reduced.

On the other hand, when the load current detected at the current detection circuit 300 is more than the threshold value, the switch control circuit 30 switches the switches 51, 52 from the off states to the on states at the same timing. Accordingly, the PWM signal generated at the PWM unit 40a is input not only to the main switching circuit 10 but also to the auxiliary switching circuit 20 via the pre-driver circuit 40b. The main switches elements 11, 12 of the main switching circuit 10 and the auxiliary switching devices 21, 22 of the auxiliary switching circuit 20 connected in parallel thereto perform the switching operations, and therefore, the on-resistance becomes small, and the continuity loss is reduced.

According to the semiconductor device 101 of the embodiment described hereinabove, only the main switching circuit 10 is driven in the low-current region. The current ratings of the main switching devices 11, 12 are small compared to the comparative example, and therefore, it is possible to reduce the switching loss compared to the comparative example. In the high-current region, the auxiliary switching circuit 20 is driven, and thereby, the continuity loss is reduced. It is thereby possible to reduce the losses regardless of the regions of the load current also when the three-phase motor is driven.

### Third Embodiment

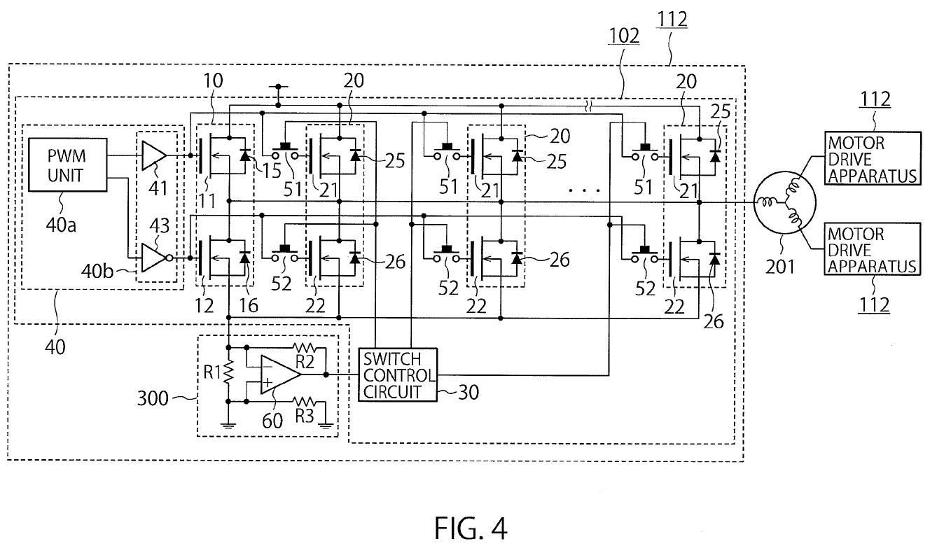

A semiconductor device according to a third embodiment is described. FIG. 4 is a view illustrating a schematic configuration of a semiconductor device 102 according to the third embodiment.

The same reference numerals are supplied to components similar to the semiconductor devices according to the first and second embodiments, and detailed descriptions are not given.

As illustrated in FIG. 4, in the embodiment, motor drive apparatus 112 are provided to correspond to respective phases of the motor 201. The motor drive apparatus 112 includes the semiconductor device 102 and the current detection circuit 300. The semiconductor device 102 is different from the semiconductor device 101 according to the second embodiment in a point that a plurality of auxiliary switching circuits 20 are included. On the other hand, the configuration of the current detection circuit 300 is similar to the first embodiment.

As illustrated in FIG. 4, the semiconductor device 102 of the embodiment includes the main switching circuit 10, the plurality of auxiliary switching circuits 20, the switch control circuit 30, and the drive control circuit 40. The main switching circuit 10 and the drive control circuit 40 are similar to the first embodiment.

Each of the plurality of auxiliary switching circuits 20 is independently controlled by the switch control circuit 30. Note that the configuration of each auxiliary switching circuit 20 is similar to the second embodiment.

The switch control circuit 30 compares the load current detected at the current detection circuit 300 with a plurality of threshold values, and the switch control circuit 30 determines the number of driven auxiliary switching circuits 20 based on a comparison result, and the switch control circuit 30 switches the switches 51, 52 from the off states to the on states in accordance with the determined number.

Hereinafter, drive operations of the motor 201 using the semiconductor device 102 of the embodiment are described.

In the embodiment, when the load current detected at the current detection circuit 300 is equal to or less than a first threshold value being a minimum among the plurality of threshold values, the switch control circuit 30 turns all of the switches 51, 52 into the off states. Therefore, the PWM signal generated at the PWM unit 40a is input only to the main switching circuit 10 via the pre-driver circuit 40b. Accordingly, only the main switching devices 11 to 14 whose input capacitances are relatively small perform the switching operations, and therefore, the switching loss is reduced.

On the other hand, when the load current detected at the current detection circuit 300 is more than the first threshold value, the switch control circuit 30 compares the load current with a second threshold value which is the smallest next to the first threshold value.

When the load current is equal to or less than the second threshold value, the switch control circuit 30 determines to drive one auxiliary switching circuit 20, and switches the switches 51, 52 which are connected to the driven auxiliary switching circuit 20 from the off states to the on states. On the other hand, when the load current is more than the second threshold value, the switch control circuit 30 compares the load current with a third threshold value which is the smallest next to the second threshold value.

When the load current is equal to or less than the third threshold value, the switch control circuit 30 determines to drive two auxiliary switching circuits 20, and switches the switches 51, 52 which are connected to each of the driven auxiliary switching circuits 20 from the off states to the on states. On the other hand, when the load current is more than the third threshold value, the switch control circuit 30 compares the load current with a fourth threshold value which is the smallest next to the third threshold value. After this, the switch control circuit 30 similarly compares the load current detected at the current detection circuit 300 with the threshold values from a smaller one in sequence, and thereby, the number of driven auxiliary switching circuits 20 increases in accordance with the load current. When the load current decreases, the switch control circuit 30 similarly compares the load current detected at the current detection circuit 300 with the threshold values from the smaller one in sequence, and thereby, the number of driven auxiliary switching circuits 20 decreases in accordance with the load current.

Note that in the embodiment, the number of driven auxiliary switching circuits 20 increases and decreases one by one. However, the increased number of driven auxiliary switching circuits 20 or decreased number of driven auxiliary switching circuits 20 may be two by two or more.

In the semiconductor device 102 of the embodiment described hereinabove, the plurality of auxiliary switching circuits 20 which are able to be independently controlled are provided, and the number of driven auxiliary switching circuits 20 is controlled in accordance with the load current. Accordingly, it is possible to perform the switching control by minutely dividing a region of the load current, and therefore, a current region where only the main switching devices 11 to 14 of the main switching circuit 10 perform the switching operations can be made small compared to the second embodiment. As a result, it is possible to apply MOSFETs whose input capacitances are smaller to the main switching devices 11 to 14, and therefore, it is possible to further reduce the switching loss. Further, it becomes possible to reduce a total loss by optimizing the switching loss and the continuity loss in accordance with the load current.

Note that the semiconductor device 102 of the embodiment may be applied to the semiconductor device 100 of the first embodiment. Specifically, the semiconductor device 100 of the first embodiment may be configured to include the plurality of auxiliary switching circuits 20 to control the number of driven auxiliary switching circuits 20 in accordance with the load current. According to the configuration, it becomes possible to further reduce the switching loss even when the single phase motor is driven.

### Fourth Embodiment

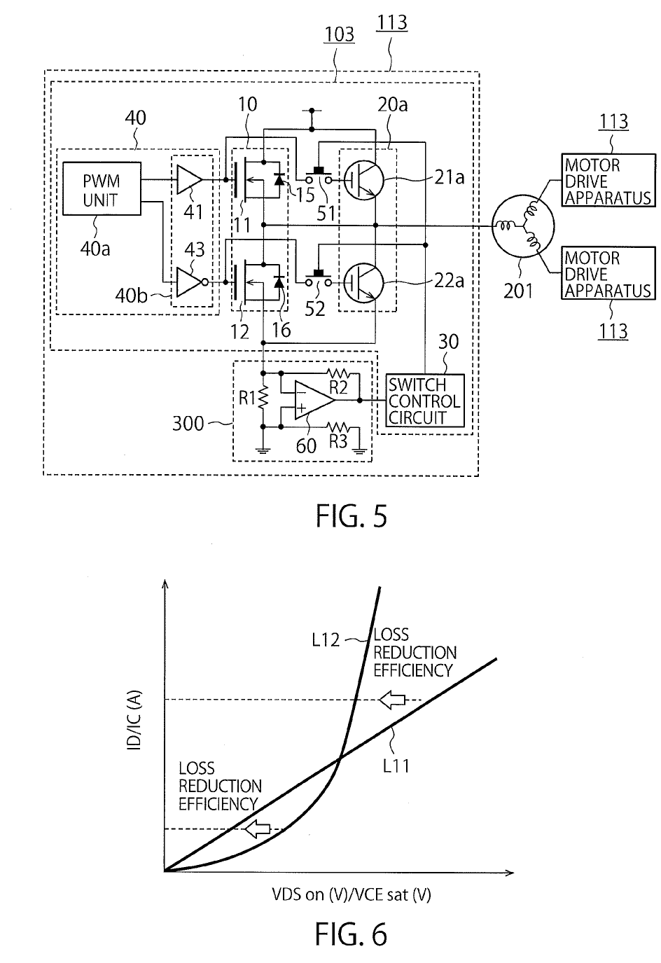

A semiconductor device according to a fourth embodiment is described. FIG. 5 is a view illustrating a schematic configuration of a semiconductor device 103 according to the fourth embodiment. The same reference numerals are supplied to components similar to the semiconductor devices according to the first to third embodiments, and detailed descriptions are not given.

As illustrated in FIG. 5, in the embodiment, motor drive apparatus 113 are provided to correspond to respective phases of the motor 201. The motor drive apparatus 113 includes the semiconductor device 103 and the current detection circuit 300. The semiconductor device 103 is different from the semiconductor device 101 according to the second embodiment in a point that an auxiliary switching circuit 20a is included. On the other hand, the configuration of the current detection circuit 300 is similar to the first embodiment, and therefore, descriptions are not given.

As illustrated in FIG. 5, the semiconductor device 103 of the embodiment includes the main switching circuit 10, the auxiliary switching circuit 20a, the switch control circuit 30, and the drive control circuit 40. The circuits other than the auxiliary switching circuit 20a are similar to the first embodiment, and therefore, descriptions are not given.

The auxiliary switching circuit 20a includes an auxiliary switching device 21a and an auxiliary switching device 22a which is connected in series to the auxiliary switching device 21a. The auxiliary switching device 21a and the auxiliary switching device 22a are IGBTs (insulated gate bipolar transistors). An emitter of the auxiliary switching device 21a and a collector of the auxiliary switching device 22a are connected to the motor 201. A gate of the auxiliary switching device 21a is connected to the buffer circuit 41 via the switch 51, and a gate of the auxiliary switching device 22a is connected to the inversion circuit 43 via the switch 52.

Hereinafter, drive operations of the motor 201 by using the semiconductor device 103 of the embodiment are described.

Also in the embodiment, when the load current detected at the current detection circuit 300 is equal to or less than the threshold value, the switch control circuit 30 keeps all of the switches 51, 52 in the off states as same as the second embodiment. Therefore, the PWM signal generated at the PWM unit 40a is input only to the main switching circuit 10 via the pre-driver circuit 40b. Accordingly, only the main switching devices 11, 12 perform the switching operations.

On the other hand, when the load current detected at the current detection circuit 300 is more than the threshold value, the switch control circuit 30 switches the switches 51, 52 from the off states to the on states at the same timing. Accordingly, the PWM signal generated at the PWM unit 40a is input not only to the main switching circuit 10 but also to the auxiliary switching circuit 20a via the pre-driver circuit 40b. The main switching devices 11, 12 and the auxiliary switching devices 21a, 22a thereby perform the switching operations.

FIG. 6 is a graphic chart comparing characteristics of the IGBT and the MOSFET. In FIG. 6, a horizontal axis is a voltage VDSon between the drain-source of the MOSFET or a voltage VCEsat between the collector-emitter of the IGBT. A vertical axis is a drain current ID of the MOSFET or a collector current IC of the IGBT. Besides, a line L11 is a line representing the characteristics of the MOSFET, and a line L12 is a line representing the characteristics of the IGBT.

As illustrated in FIG. 6, in the high-current region, the voltage VCEsat is lower than VDSon. Namely, in the high-current region, the continuity loss of the IGBT is smaller than the MOSFET.

Therefore, according to the semiconductor device 103 of the embodiment, the auxiliary switching devices 21a, 22a of the auxiliary switching circuit 20a are configured to the IGBTs, and the IGBTs are controlled to perform the switching operations in the region where the load current is high. Accordingly, it becomes possible to further reduce the continuity loss in the high-current region compared to the semiconductor devices according to the first to third embodiments where the switching devices of the auxiliary switching circuit 20a are configured to the MOSFETs.

Besides, according to the semiconductor device 103 of the embodiment, the auxiliary switching devices 21a, 22a being the IGBTs are connected in parallel to the main switching devices 11, 12 being the MOSFETs. Therefore, it is possible to use the body diodes housed in the MOSFETs as reflux diodes. As a result, there is no need to newly provide the reflux diodes. Accordingly, a disposition space of freewheel diodes can be reduced, and therefore, it becomes possible to suppress increase in size of the device.

Note that the semiconductor device 103 of the embodiment may be applied to the semiconductor device 100 of the first embodiment. Specifically, the semiconductor device 100 of the first embodiment may be configured to include the auxiliary switching circuit 20a instead of the auxiliary switching circuit 20. According to the configuration, it becomes possible to further reduce the continuity loss in the high-current region even when the single phase motor is driven.

Besides, the semiconductor device 103 of the embodiment may be applied to the semiconductor device 102 of the third embodiment. Specifically, the semiconductor device 102 of the third embodiment may be configured to include a plurality of auxiliary switching circuits 20a. According to the configuration, it becomes possible to further reduce the continuity loss in the high-current region.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A semiconductor device, comprising:
a first switching circuit to drive a motor;
at least one second switching circuit connected in parallel to the first switching circuit, and to supply a current to the motor; and
a switch control circuit to control whether or not to drive the second switching circuit in accordance with a current flowing to the motor.

2. The semiconductor device according to claim 1, wherein a plurality of the second switching circuits which are able to be independently controlled are connected in parallel to the first switching circuit, and
the switch control circuit independently drives the plurality of second switching circuits corresponding to the current flowing to the motor.

3. The semiconductor device according to claim 2, wherein the switch control circuit compares the current flowing to the motor with a plurality of threshold values, and the switch control circuit controls the number of driven second switching circuits based on a comparison result.

4. The semiconductor device according to claim 3, wherein the switch control circuit increases and decreases the number of driven second switching circuits one by one based on the comparison result between the current flowing to the motor and the plurality of threshold values.

5. The semiconductor device according to claim 3, wherein the switch control circuit increases and decreases the number of driven second switching circuits two by two or more based on the comparison result between the current flowing to the motor and the plurality of threshold values.

6. The semiconductor device according to claim 1, wherein the first switching circuit includes at least one first switching device,
the second switching circuit includes at least one second switching device which is connected in parallel to the first switching device via a switch, and
the switch control circuit controls whether or not to drive the second switching circuit by controlling the switch in accordance with the current flowing to the motor.

7. The semiconductor device according to claim 6, wherein a plurality of the first switching devices are provided at the first switching circuit,
a plurality of the second switching devices are provided at the second switching circuit;
the switch is provided between each of the plurality of the first switching devices and each of the plurality of the second switching devices, and
the switch control circuit switches all of the switches from off states to on states when the current flowing to the motor is more than a threshold value.

8. The semiconductor device according to claim 6, wherein the first switching device is a MOSFET, and the second switching device is an IGBT.

9. A motor driving method, comprising:
a first step of driving a motor by a first switching circuit; and
a second step of controlling whether or not to drive at least one second switching circuit connected in parallel to the first switching circuit in accordance with a current flowing to the motor.

10. The motor driving method according to claim 9, wherein in the second step, a plurality of second switching circuits which are connected in parallel to the first switching circuit and which are able to be independently controlled, are independently driven corresponding to the current flowing to the motor.

11. The motor driving method according to claim 10, wherein in the second step, the current flowing to the motor is compared with a plurality of threshold values, and the number of driven second switching circuits are controlled based on a comparison result.

12. The motor driving method according to claim 11, wherein in the second step, the number of driven second switching circuits is increased and decreased one by one based on the comparison result between the current flowing to the motor and the plurality of threshold values.

13. The motor driving method according to claim 11, wherein in the second step, the number of driven second switching circuits is increased and decreased two by two or more based on the comparison result between the current flowing to the motor and the plurality of threshold values.
